(19) United States
(12) Patent Application Publication
(10) Pub. No.: US 2014/0106298 A1
(43) Pub. Date: Apr. 17, 2014

(54) Clinical Dispenser and Applicator

(71) Applicant: Dorothy Kassab, Canastota, NY (US)

(72) Inventor: Dorothy Kassab, Canastota, NY (US)

(21) Appl. No.: 13/856,234

(22) Filed: Apr. 3, 2013

Related U.S. Application Data
(60) Provisional application No. 61/713,154, filed on Oct. 12, 2012.

(51) Int. Cl. A61C 19/06; A61C 3/00

(52) U.S. Cl. CPC A61C 19/06; A61C 3/005
USPC 433/89; 433/226

(57) ABSTRACT

The present invention relates to a clinical dispenser and applicator and, more particularly, to a clinical dispenser and applicator that is structured to hold and dispense a micro amount (one to several drops) of liquids/solvents in a clinical setting.

### RELATED APPLICATION DATA

The present application claims the benefit of U.S. provisional patent application No. 61/713154, filed Oct. 12, 2012, and is hereby incorporated by reference in its entirety.

### BACKGROUND OF THE INVENTION

1. Field of the Invention

The present invention relates to a clinical dispenser and applicator and, more particularly, to a clinical dispenser and applicator that is structured to hold and dispense a micro amount (one to several drops) of liquids/solvents in a clinical setting.

2. Description of the Related Art

Conventional dispensers/applicators include Microbrush® products which are used to clinically apply liquids/solvents to areas of limited access in the field of dentistry (among other uses). FIG. 1 shows a Microbrush® dispenser/applicator 100, which includes a fiber applicator tip 10, an angled neck 20, and a shaft 30.

The most common use of a Microbrush® applicator is the application of costly liquids that require one or 2 drops clinically, such as application of bonding agents and primers to tooth structure or application of silane, or Viscostat®/hemostatic agents. Current dispensers contain syringe type reservoirs that attach to the tip of the dispenser, but are not practical in use of dispensing/applying one or two drops. Also, these types of dispensers take extra steps to fill and screw on the tip and are more costly to manufacture.

The common method of application using the Microbrush® dispenser/applicator is to dispense one to two drops in a well and then dip the dispenser/applicator repeatedly, and use clinically, until the liquid is used up or following the manufacturer's recommendation as to the necessary clinically applied liquid layers.

Description of the Related Art Section Disclaimer: To the extent that specific patents/publications/products are discussed above in this Description of the Related Art Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Description of the Related Art Section and/or throughout the application, the descriptions/disclosures of which are all hereby incorporated by reference into this document in their respective entirety(ies).

### SUMMARY OF THE INVENTION

The present invention recognizes that there are potential problems and/or disadvantages with the conventional dispensers/applicators. First, bonding materials evaporate as they sit dispensed in a well waiting to be applied to teeth. Evaporation decreases effectiveness of bonding materials. Second, repeated dipping of dispensers/applicators to transfer bonding materials to teeth is cumbersome for the clinician. Third, repeated dipping of dispensers/applicators to transfer bonding materials to teeth takes more time and provides opportunity for contamination by saliva and/or possibility of moisture in the bonding process. Fourth, not having the exact amount available for use promotes waste of bonding materials as more drops are dispensed because there is ineffectiveness/inefficiency of bonding agent application. Fifth, repeated dipping provides a possibility of droplets splatter on the patient as it drops during carry over from the well to the mouth. Sixth, dispensing liquids from a syringe-type dispenser is hard to control by the operator and results in splatter of the liquid and resulting waste of the costly liquid (ex: silane dispensing in ceramic restorations). Various embodiments of the present invention may be advantageous in that they may solve or reduce one or more of the potential problems and/or disadvantages discussed above.

Various embodiments of the present invention may exhibit one or more of the following objects, features and/or advantages:

It is therefore a principal object and advantage of the present invention to provide a clinical dispenser and applicator that is adapted and/or structured to deliver/dispense liquids/solvents in a clinical setting with little or no evaporation of such liquids/solvents (such as bonding materials) as compared with the conventional dispensers/applicators.

It is another object and advantage of the present invention to provide a clinical dispenser and applicator that is adapted and/or structured to allow for elimination of repeated dipping of the dispenser/applicator to transfer bonding materials (or other liquids/solvents) to teeth which will be less cumbersome for the clinician especially in multiple teeth treatment.

It is a further object and advantage of the present invention to provide a clinical dispenser and applicator that is adapted and/or structured to allow for elimination of repeated dipping of the dispenser/applicator to transfer bonding materials (or other liquids/solvents) to teeth which will take less time and provide less opportunity for contamination by saliva and/or possibility of moisture in the bonding process.

It is another object and advantage of the present invention to provide a clinical dispenser and applicator that is adapted and/or structured to provide a more precise to an exact required amount of bonding agent (or other liquids/solvents) available for use and a decrease in bonding materials waste.

In accordance with the foregoing objects and advantages, an embodiment of the present invention is directed a clinical dispenser and applicator that can include a distal shaft extending along a longitudinal axis, at least a portion of which is hollowed out (i.e., a reservoir portion), a neck portion which is bent at an angle from the shaft (preferable about 45 degrees), a hollowed out proximal tube portion and a fiber applicator tip. The hollowed out proximal tube portion includes an exit hole, and the distal shaft is closed off at the most distal end. Stated differently, a clinical dispenser and applicator is provided comprising one or more of the following: an elongated distal shaft extending along a longitudinal axis, a portion of which is hollowed-out defining a material reservoir beginning at a proximal end thereof; a proximal applicator portion comprising: a tubular neck portion attached to the proximal end of the distal shaft and comprising a bend at an angle from the longitudinal axis, and a proximal tube portion comprising an exit hole; and wherein the hollowed-out portion of the distal shaft is configured to be squeezable to create a vacuum to suction a material into the material reservoir through the exit hole from a well containing the material and to dispense the material from the material reservoir through the exit hole onto a predetermined area of interest.

In use, the distal shaft portion can be squeezed to suction up a dispensed drop or 2 drops of bonding agent, for example. The negative pressure and capillary action will draw up the drop or 2 drops up into the reservoir portion of the distal shaft portion. In a preferable embodiment, there will be one or 2 drops available for application as a clinician squeezes again the distal shaft portion and the bonding agent will come out of the exit hole. Thus, most preferably, once a liquid is sucked up into the reservoir portion of the distal shaft portion it will not drop or spill out by itself until the clinician squeezes the handle; which therefore provides controlled and safe dispensing without wasting.

In accordance with another embodiment of the present invention, a method is provided comprising one or more of the following: a method of applying a dental composition to a tooth structure, comprising the steps of: providing a clinical dispenser and applicator comprising: an elongated distal shaft extending along a longitudinal axis, a portion of which is hollowed-out defining a material reservoir beginning at a proximal end thereof, wherein the material reservoir contains a dental composition; a proximal applicator portion comprising: a tubular neck portion attached to the proximal end of the distal shaft and comprising a bend at an angle from the longitudinal axis, and a proximal tube portion comprising an exit hole; and wherein the hollowed-out portion of the distal shaft is configured to be squeezable to dispense the dental composition from the material reservoir through the exit hole onto a tooth structure; placing the exit hole next to the tooth structure; and squeezing the hollowed-out portion of the distal shaft in order to dispense at least a portion of the dental composition onto the tooth structure.

In accordance with a further embodiment, a method is provided comprising one or more of the following: a method of applying a dental composition to a tooth structure, comprising the steps of: providing a clinical dispenser and applicator comprising: an elongated distal shaft extending along a longitudinal axis, a portion of which is hollowed-out defining a material reservoir beginning at a proximal end thereof; a proximal applicator portion comprising: a tubular neck portion attached to the proximal end of the distal shaft and comprising a bend at an angle from the longitudinal axis, and a proximal tube portion comprising an exit hole; and wherein the hollowed-out portion of the distal shaft is configured to be squeezable to dispense the dental composition from the material reservoir through the exit hole onto a tooth structure; wherein the hollowed-out portion of the distal shaft is configured to be squeezable to create a vacuum to suction a dental composition into the material reservoir through the exit hole from a well containing the dental composition and to dispense the dental composition from the material reservoir through the exit hole onto a tooth structure; placing the exit hole into a well containing the dental composition; squeezing the hollowed-out portion of the distal shaft; releasing the hollowed-out portion of the distal shaft in order to suction an amount of the dental composition into the material reservoir; placing the exit hole next to the tooth structure; and squeezing the hollowed-out portion of the distal shaft in order to dispense at least a portion of the dental composition onto the tooth structure.

### BRIEF DESCRIPTION OF THE DRAWINGS

The present invention will be more fully understood and appreciated by reading the following Detailed Description in conjunction with the accompanying drawings, in which:

FIG. 1 is a side perspective view of a conventional Microbrush® dispenser/applicator.

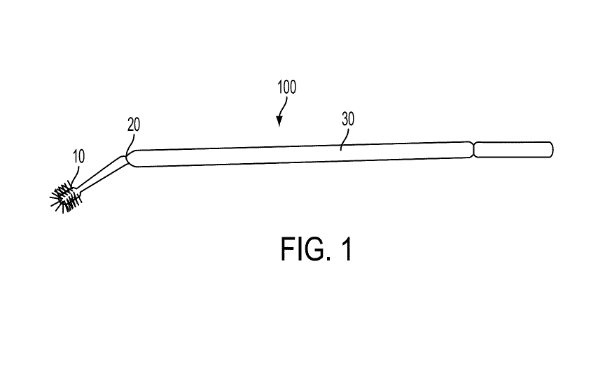

FIG. 2 is a side perspective view of a clinical dispenser and applicator, according to an embodiment of the present invention.

FIG. 3a-b are photographs illustrating the use of the clinical dispenser and applicator collecting and dispensing one to two drops of bonding agent by squeezing the proximal shaft portion, according to an embodiment of the present invention.

FIG. 4 is a photograph showing an experimental comparison between a (i) clinical dispenser and applicator of an embodiment of the present invention and (ii) conventional Microbrush® dispenser/applicator.

FIG. 5a-b are photographs showing an experimental demonstration of and a comparison of the amount of liquid available for use with conventional Microbrush® dispenser/applicator vs. clinical dispenser and applicator of an embodiment of the present invention.

FIG. 6 shows a side perspective view of a clinical dispenser and applicator, according to an alternative embodiment of the present invention.

FIG. 7 is a side perspective view of a clinical dispenser and applicator, according to an embodiment of the present invention.

### DETAILED DESCRIPTION

The present invention will be more fully understood and appreciated by reading the following Detailed Description in conjunction with the accompanying drawings, wherein like reference numerals refer to like components. Certain dimensions are listed in some of the drawings, however, these dimensions are exemplary and embodiments of the present invention are not limited to these dimensions.

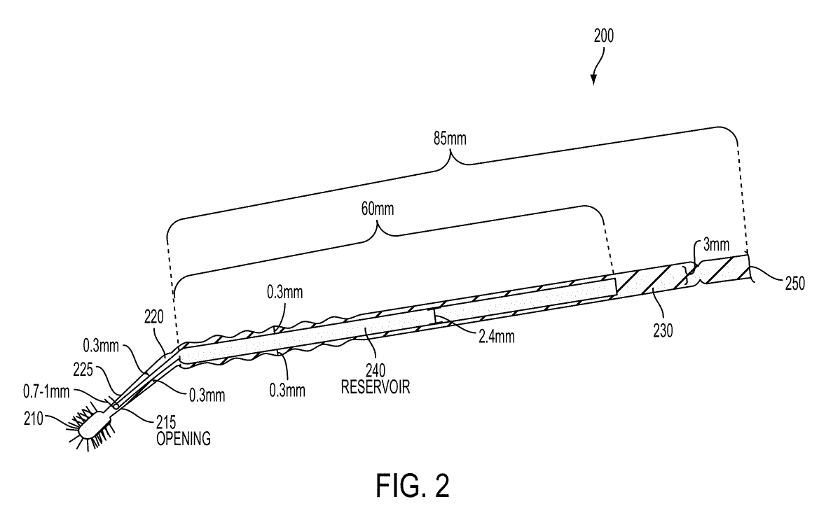

As shown in FIG. 2, a side perspective view of a clinical dispenser and applicator is illustrated, according to an embodiment of the present invention. The clinical dispenser and applicator 200 can include a distal shaft 230 extending along a longitudinal axis, at least a portion of which is hollowed out (i.e., a reservoir portion) 240, a neck portion 220 which is bent at an angle from the shaft (preferable about 45 degrees), a hollowed out proximal tube portion 225 and a fiber applicator tip 210. The hollowed out proximal tube portion includes an exit hole 215, and the distal shaft is closed off at the most distal end 250.

The proximal tube portion 225 can be 0.2-0.3 mm thick, about the thickness of a coffee stirrer with a narrowed area near the opening 215 (which can be bendable; could be accordion crimped similar to a bend in a drinking straw) and thinner in diameter near the tip to maintain the small size convenient for narrow treatment areas. Other measurements shown in FIG. 2 relate to a preferred embodiment of the present invention.

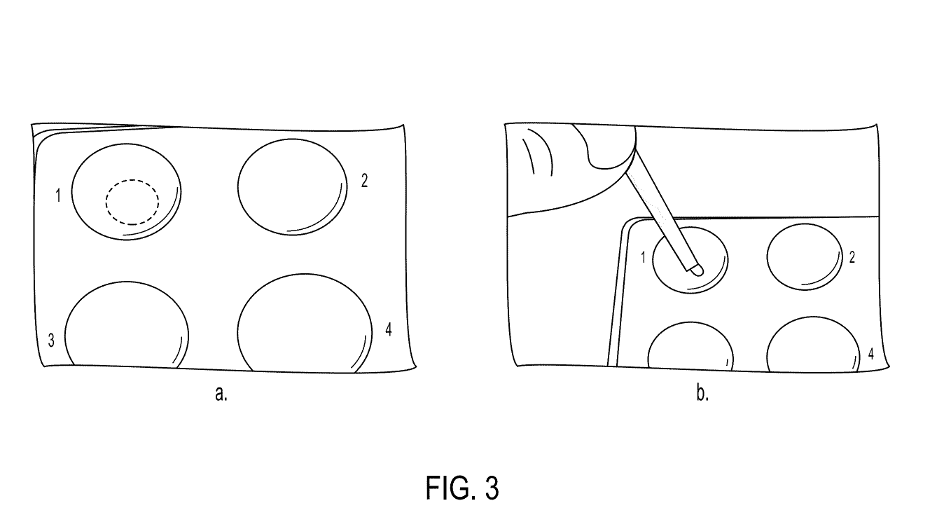

FIG. 3a-b are photographs illustrating the use of the clinical dispenser and applicator collecting and dispensing one to two drops of bonding agent by squeezing the proximal shaft portion, according to an embodiment of the present invention.

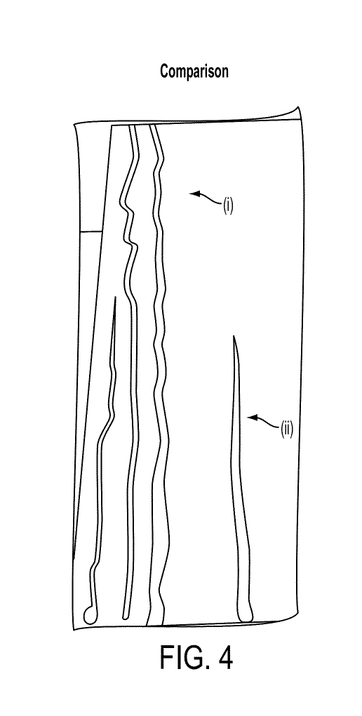

FIG. 4 is a photograph showing a comparison between a (i) clinical dispenser and applicator of an embodiment of the present invention and (ii) a conventional Microbrush® dispenser/applicator. As shown in (i), the clinical dispenser and applicator of an embodiment of the present invention shows that there is almost twice as much of bonding agent available for use after one squeeze of the clinical dispenser and applicator, as compared to (ii) which illustrates the amount of bonding agent available for use after single dip of the Microbrush® dispenser/applicator tip in a dispensed drop in a well.

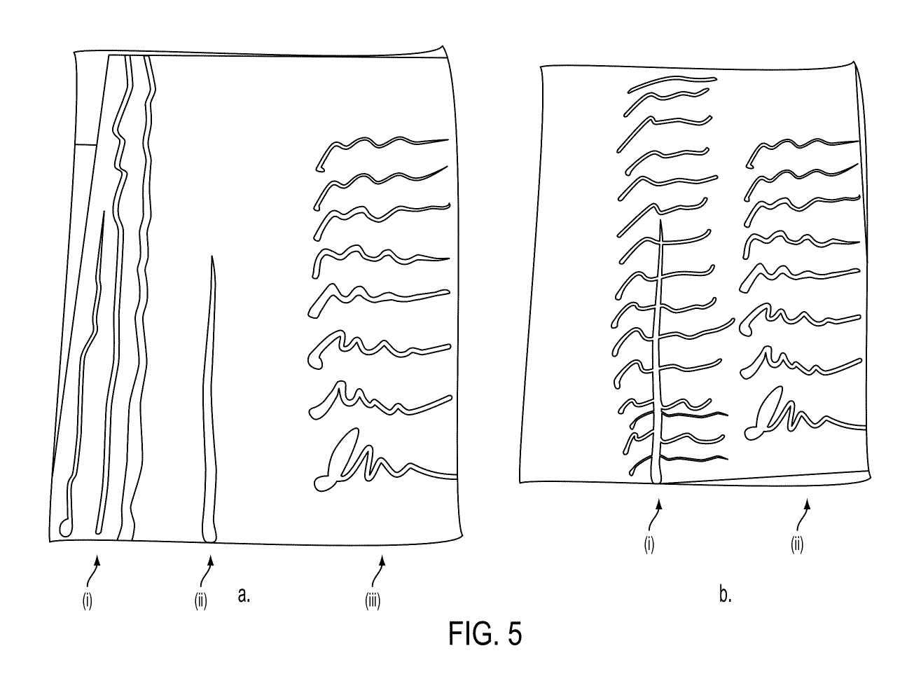

FIG. 5a-b are photographs showing an experimental demonstration of a comparison of the amount of liquid available for use with conventional Microbrush® dispenser/applicator vs. clinical dispenser and applicator of an embodiment of the present invention. In brief, these photographs show available bonding agent and number of repeated dips needed during the use of a conventional Microbrush® dispenser/applicator vs. one squeeze of a clinical dispenser and applicator of an embodiment of the present invention containing the same amount of bonding agent as in the separate dipping reservoir used for the conventional Microbrush® dispenser/applicator. FIG. 5a(i)-(ii) show a similar demonstration as shown in FIG. 4(i)-(ii). FIG. 5a(iii) shows the number of dips (8 total) necessary to use up one drop of bonding agent with the conventional Microbrush® dispenser/applicator.

Turning to FIG. 5b, (i) shows that one full squeeze of a clinical dispenser and applicator of an embodiment of the present invention containing one drop of bonding agent is able to provide 12 applications without dipping. In comparison, 5b(ii) shows that 8 dips of the conventional Microbrush® dispenser/applicator is necessary to use up one drop of bonding agent. The difference in application performance is due to the issues referenced above including evaporation or splattering of the bonding agent, for example, when using the conventional Microbrush® dispenser/applicator.

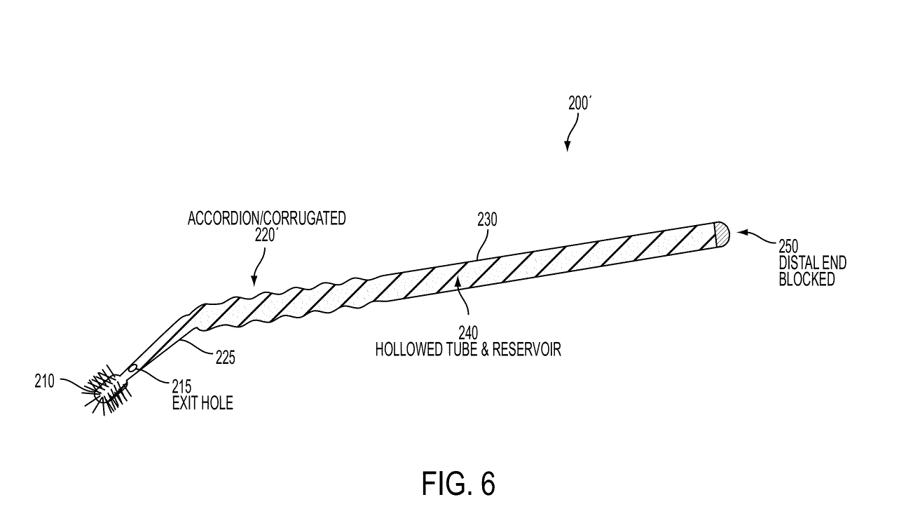

FIG. 6 shows a side perspective view of a clinical dispenser and applicator, according to an alternative embodiment of the present invention. The clinical dispenser and applicator 200′ can include a distal shaft 230 extending along a longitudinal axis, at least a portion of which is hollowed out (i.e., a reservoir portion) 240, a neck portion 220′ which is bent at an angle from the shaft (preferable about 45 degrees) and has an accordion/corrugated structure, a hollowed out proximal tube portion 225 and a fiber applicator tip 210. The hollowed out proximal tube portion includes an exit hole 215, and the distal shaft is closed off at the most distal end 250.

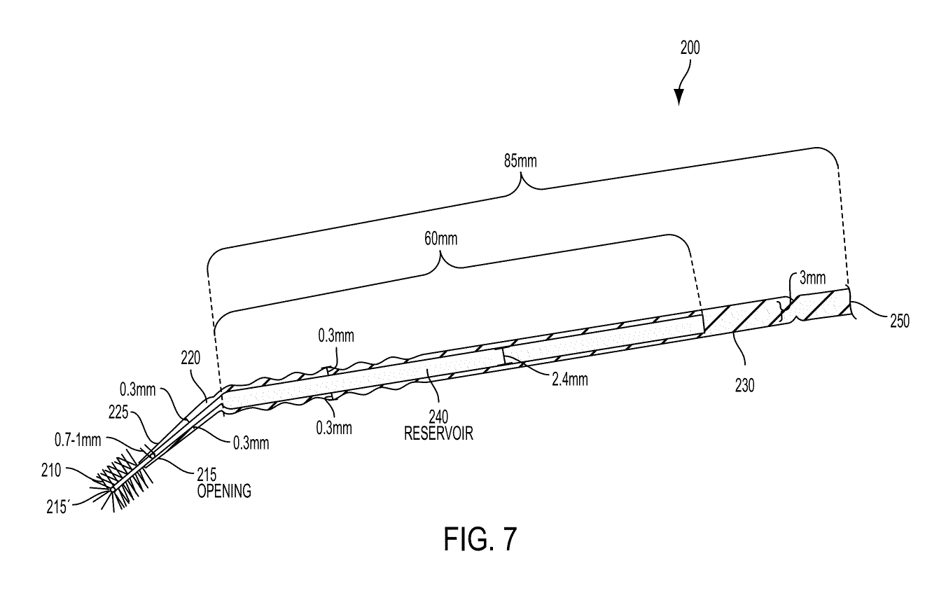

FIG. 7 shows a side perspective view of a clinical dispenser and applicator, according to an embodiment of the present invention. The clinical dispenser and applicator FIG. 7 is similar to the clinical dispenser and applicator in FIG. 2, and shows a clinical dispenser and applicator 200 that can include a distal shaft 230 extending along a longitudinal axis, at least a portion of which is hollowed out (i.e., a reservoir portion) 240, a neck portion 220 which is bent at an angle from the shaft (preferable about 45 degrees), a hollowed out proximal tube portion 225 and a fiber applicator tip 210. The hollowed out proximal tube portion can include an exit hole 215 at the distal end of the fiber applicator tip 210 or at the proximal end thereof (215′), and the distal shaft is closed off at the most distal end 250.

While several embodiments of the invention have been discussed, it will be appreciated by those skilled in the art that various modifications and variations of the present invention are possible. Such modifications do not depart from the spirit and scope of the present invention.

What is claimed is:

1. A clinical dispenser and applicator comprising:
an elongated distal shaft extending along a longitudinal axis, a portion of which is hollowed-out defining a material reservoir beginning at a proximal end thereof;
a proximal applicator portion comprising:
a tubular neck portion attached to the proximal end of said distal shaft and comprising a bend at an angle from the longitudinal axis, and
a proximal tube portion comprising an exit hole; and
wherein said hollowed-out portion of said distal shaft is configured to be squeezable to create a vacuum to suction a material into said material reservoir through said exit hole from a well containing the material and to dispense the material from said material reservoir through said exit hole onto a predetermined area of interest.

2. The clinical dispenser and applicator of claim 1, wherein said proximal applicator portion further comprises a fiber applicator tip.

3. The clinical dispenser and applicator of claim 1, wherein said material comprises a dental composition.

4. The clinical dispenser and applicator of claim 3, wherein said dental composition comprises a composition selected from the group consisting of bonding materials, primers, silane and hemostatic agents.

5. The clinical dispenser and applicator of claim 4, wherein said predetermined area of interest comprises a tooth structure.

6. The clinical dispenser and applicator of claim 1, wherein said proximal shaft is closed off at a distal end thereof.

7. The clinical dispenser and applicator of claim 1, wherein the diameter of said proximal tube portion narrows from the distal end to the proximal end thereof.

8. The clinical dispenser and applicator of claim 1, wherein said tubular neck portion is corrugated.

9. A method of applying a dental composition to a tooth structure, comprising the steps of:
providing a clinical dispenser and applicator comprising:
an elongated distal shaft extending along a longitudinal axis, a portion of which is hollowed-out defining a material reservoir beginning at a proximal end thereof, wherein said material reservoir contains a dental composition;
a proximal applicator portion comprising:
a tubular neck portion attached to the proximal end of said distal shaft and comprising a bend at an angle from the longitudinal axis, and
a proximal tube portion comprising an exit hole; and
wherein said hollowed-out portion of said distal shaft is configured to be squeezable to dispense the dental composition from said material reservoir through said exit hole onto a tooth structure;
placing said exit hole next to the tooth structure; and
squeezing said hollowed-out portion of said distal shaft in order to dispense at least a portion of the dental composition onto the tooth structure.

10. A method of applying a dental composition to a tooth structure, comprising the steps of:
providing a clinical dispenser and applicator comprising:
an elongated distal shaft extending along a longitudinal axis, a portion of which is hollowed-out defining a material reservoir beginning at a proximal end thereof;
a proximal applicator portion comprising:
a tubular neck portion attached to the proximal end of said distal shaft and comprising a bend at an angle from the longitudinal axis, and
a proximal tube portion comprising an exit hole; and
wherein said hollowed-out portion of said distal shaft is configured to be squeezable to dispense the dental composition from said material reservoir through said exit hole onto a tooth structure;
wherein said hollowed-out portion of said distal shaft is configured to be squeezable to create a vacuum to suction a dental composition into said material reservoir through said exit hole from a well containing the dental composition and to dispense the dental composition from said material reservoir through said exit hole onto a tooth structure;
placing said exit hole into a well containing the dental composition;
squeezing said hollowed-out portion of said distal shaft;
releasing said hollowed-out portion of said distal shaft in order to suction an amount of the dental composition into said material reservoir;
placing said exit hole next to the tooth structure; and
squeezing said hollowed-out portion of said distal shaft in order to dispense at least a portion of the dental composition onto the tooth structure.
